(19) United States
(12) Patent Application Publication
(10) Pub. No.: US 2014/0200960 A1
(43) Pub. Date: Jul. 17, 2014

(54) SYSTEM AND METHODS FOR OPTIMIZING RECRUITMENT

(71) Applicant: PALO ALTO RESEARCH CENTER INCORPORATED, Palo Alto, CA (US)

(72) Inventors: Nicolas B. Ducheneaut, Sunnyvale, CA (US); Victoria M.E. Bellotti, San Francisco, CA (US); Nicholas K. Yee, Mountain View, CA (US)

(73) Assignee: PALO ALTO RESEARCH CENTER INCORPORATED, Palo Alto, CA (US)

(21) Appl. No.: 13/743,049

(22) Filed: Jan. 16, 2013

(51) Int. Cl. G06Q 30/02

(52) U.S. Cl. CPC G06Q 30/0204
USPC 705/7.33

(57) ABSTRACT

One embodiment of the present invention provides a system for recruiting individuals with a desired socio-demographic distribution. During operation, the system receives the desired socio-demographic distribution, obtains a seed sample comprising a plurality of participants, calculates a socio-demographic distribution associated with the seed sample, calculates an incentive provided to a user for recruiting an individual with a desired socio-demographic attribute, and presents the incentive to the user, thereby motivating the user to recruit the individual with the desired socio-demographic attribute.

### BACKGROUND

1. Field

This disclosure is generally related to recruiting a balanced sample of individuals. More specifically, this disclosure is related to a system that implements a gamified user interface for optimizing the recruitment result.

2. Related Art

Recruiting a balanced sample of individuals, based on a set of baseline socio-demographic variables, is essential in a variety of domains that try to gather information from a large population, such as academic and commercial research, marketing, hiring, etc. However, traditional ways of recruiting individuals to participate in a survey, such as an open call, often lead to an unbalanced sample and, thus, biased results.

### SUMMARY

One embodiment of the present invention provides a system for recruiting individuals with a desired socio-demographic distribution. During operation, the system receives the desired socio-demographic distribution, obtains a seed sample comprising a plurality of participants, calculates a socio-demographic distribution associated with the seed sample, calculates an incentive provided to a user for recruiting an individual with a desired socio-demographic attribute, and presents the incentive to the user, thereby motivating the user to recruit the individual with the desired socio-demographic attribute.

In a variation on this embodiment, the system further displays visual representations of the calculated socio-demographic distribution and the desired socio-demographic distribution.

In a further variation, the visual representations include at least one of: a pie chart, a histogram, a table, and a statistical map.

In a variation on this embodiment, calculating the incentive involves comparing a difference between the calculated socio-demographic distribution and the desired socio-demographic distribution.

In a variation on this embodiment, the system receives socio-demographic variables associated with a participant via an online survey.

In a further variation, the system stores the received socio-demographic variables in a database.

In a variation on this embodiment, the incentive includes at least one of: a monetary incentive, and a non-monetary incentive.

### BRIEF DESCRIPTION OF THE FIGURES

FIG. 1 presents a diagram illustrating an exemplary computing environment, in accordance with an embodiment of the present invention.

FIG. 2 presents a diagram illustrating an exemplary graphical representation of distributions of socio-demographic variables for a sample body.

FIG. 3 presents a diagram illustrating an exemplary user interface (UI) for providing recruiting incentives, in accordance with an embodiment of the present invention.

FIG. 4 presents a diagram illustrating an exemplary architecture of a sample-recruiting server, in accordance with an embodiment of the present invention.

FIG. 5 presents a flowchart illustrating an exemplary process of sample recruiting, in accordance with an embodiment of the present invention.

FIG. 6 illustrates an exemplary computer system for sample recruiting, in accordance with one embodiment of the present invention.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention provide a sample-gathering system that uses a gamified user interface (UI) to recruit potential participants via currently enrolled participants. More specifically, the UI presents the currently enrolled participants with a graphical representation of the desired sample-distribution result and the current sample distribution. The enrolled participants are also offered rewards, monetary or otherwise, to recruit individuals that can improve the balance of the sample.

In this disclosure, the term “user” refers to people who access the sample-gathering system. The term “user” and the term “participant” are exchangeable in this disclosure.

### Gamified User Interface

Surveying is a powerful tool in providing information for all kinds of research fields, such as marketing research, psychology, health professionals, and sociology. By sampling individuals from a large population, one can make statistical inferences about the population using the sample. For example, to find out public opinion about certain issues, opinion polls are regularly conducted by news media or government agencies.

Because the survey research is based on a sample of the population, the success of the research or the accuracy of the result depends on the representativeness of the population of concern. Hence, it is important to obtain a sample that represents the population without any bias. For example, a particular research study may want to test whether a hypothesis applies to the U.S. population as a whole. To obtain an accurate result, one needs to recruit a large enough number of participants such that their combined socio-demographic profiles approximate, as much as possible, the distribution found in the U.S. Census. However, traditional ways of recruiting, such as an open call to the public, often lead to an unbalanced sample. For example, people who volunteer to participate in the research may have a higher-than-average education level.

Another effective way for recruiting survey or research participants is the so-called “snowball” approach that relies on current participants to recruit more future participants. Although the snowball approach can increase the sample size in a short time, it often results in an even more unbalanced sample since people tend to recruit from their closest social circle; in other words, people tend to recruit more people just like themselves. It can be very expensive for a company to hire survey professionals that recruit from multiple channels to obtain a balanced sample.

To overcome such a problem, embodiments of the present invention provide a recruiting system that smartly incentivizes users for recruiting future survey participants that can help retain the balance of the overall sample.

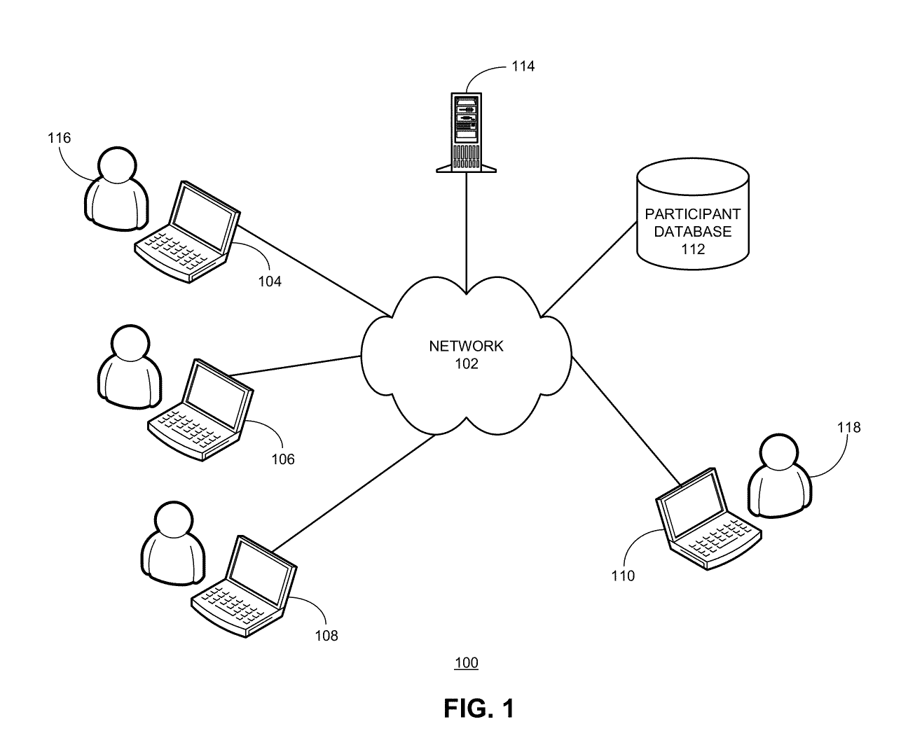

FIG. 1 presents a diagram illustrating an exemplary computing environment, in accordance with an embodiment of the present invention. Computing environment 100 can generally include any type of computer system including, but not limited to, a computer system based on a microprocessor, a mainframe computer, a digital signal processor, a portable computing device, a personal organizer, a device controller, and a computational engine within an appliance. In the example illustrated in FIG. 1, computing environment 100 includes a network 102, clients 104, 106, 108, and 110, a participant database 112, and a sample-recruiting server 114.

Network 102 can generally include any type of wired or wireless communication channel capable of coupling together computing nodes. This includes, but is not limited to, a local area network, a wide area network, or a combination of networks. In one embodiment of the present invention, network 102 includes the Internet.

Clients 104-110 can generally include any nodes on a network with computational capability and a mechanism for communicating across the network. Sample-recruiting server 114 includes any computational node with a mechanism for providing a recruiting user interface (recruiting-UI) to a client. Users of clients 104-110 can access sample-recruiting server 114 via network 102. For example, a user 116 of client 104 can access sample-recruiting server 112 and use the recruiting-UI. In one embodiment, the recruiting-UI is in the form of a web page. Participant database 112 can generally include any type of system for storing data associated with participants in non-volatile storage. This includes, but is not limited to, systems based upon magnetic, optical, and magneto-optical storage devices, as well as storage devices based on flash memory and/or battery-backed up memory.

During operation, a system administrator (or a recruiter) initializes the system by providing a target sample distribution. In the aforementioned exemplary research study regarding the U.S. population as a whole, the target sample distribution can be the census result. Depending on the needs of the study, countless variations of the sample distribution are also possible. For example, some female-oriented product research may want to construct a sample that includes only women. The recruiter then constructs an initial sample that includes seed participants. In one embodiment, the recruiter obtains the seed participants by issuing open calls to the general public and receiving responses. Note that the open calls can be issued over various channels, such as advertising in online or offline media.

A number of users respond to the open call by providing their socio-demographic information to sample-recruiting server 114. In one embodiment a user, such as user 116, enters his socio-demographic info in an online survey, which is either hosted by sample-recruiting server 114 or accessible to sample-recruiting server 114. The recruiter can then screen the responders based on their socio-demographic variables and the research need to select desired participants. In one embodiment, the screening is performed automatically by a program. The socio-demographic info of the selected participants can be stored in participant database 112.

Once a minimum number of suitable participants are accumulated via the open-call-and-screening process, sample-recruiting server 114 can generate a graphical representation of the current sample distribution based on the socio-demographic information associated with the participants and a graphical representation of the desired sample distribution. These two graphs can be displayed to all responders (including those not selected). In one embodiment, sample-recruiting server 114 provides a graphical user interface (GUI) that displays these two graphs. By displaying the current distribution and the desired distribution side-by-side, the GUI allows a user to view the discrepancies between the current distribution and the desired distribution. Moreover, the GUI provides a way, and incentivizes a user, to recruit future participants (most likely through their own social network) that can reduce such discrepancies. For example, using such a GUI, user 116 may recruit user 118, who participates by accessing sample-recruiting server 114 via client 110. Sample-recruiting server 114 dynamically updates the sample-distribution graph and the incentives for recruiting under-represented participants based on currently enrolled participants. For example, recruiting a participant in the most under-represented category is often rewarded with the greatest incentive. In other words, individuals with the most desired socio-demographic attributes are the most valuable recruitment targets. As more people in such a category enroll, the incentive is gradually reduced. In one embodiment, sample-recruiting server 114 runs an algorithm to compute incentive values for new recruits, and presents these values to users. In a further embodiment, sample-recruiting server 114 computes incentive values for new recruits based on the difference between the current sample distribution and the desired sample distribution.

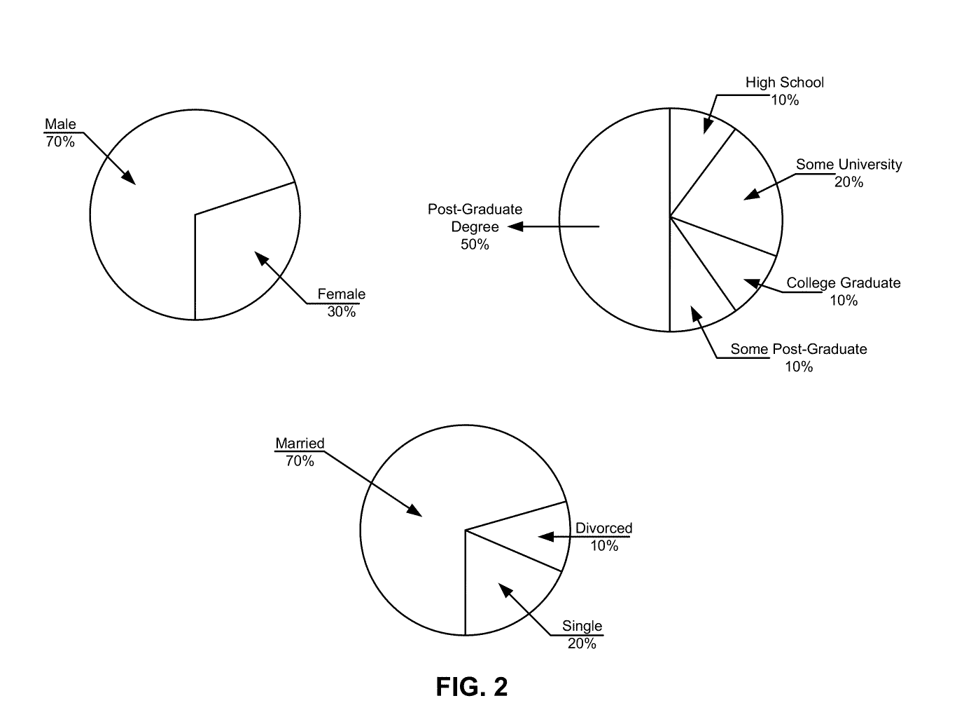

FIG. 2 presents a diagram illustrating an exemplary graphical representation of distributions of socio-demographic variables for a sample body. In FIG. 2, pie charts are used to illustrate the distribution of various socio-demographic variables, such as gender, education level, marital status, and geographic location, associated with individuals within the sample body. Note that other forms of visual representation including, but not limited to, histograms and statistical maps, are also possible for illustrating the sample distribution. Depending on the type of socio-demographic variable, a particular chart type may be preferred. For example, a pie chart may be ideal for expressing gender distribution, whereas a histogram may be preferred for expression of age distribution. Moreover, if locations are concerned (such as gender distribution across the country), maps with dots or other visualizations may be the best.

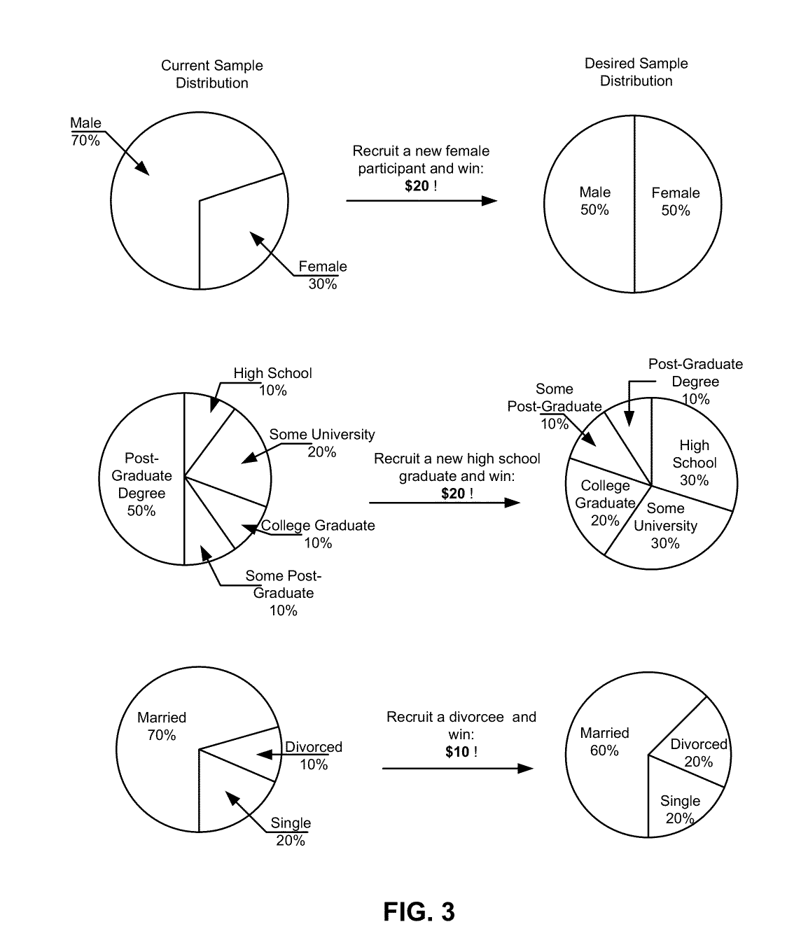

FIG. 3 presents a diagram illustrating an exemplary user interface (UI) for providing recruiting incentives, in accordance with an embodiment of the present invention. The UI displays the charts (such as pie charts) for the current sample distribution and the charts for the desired sample distribution. In the example shown in FIG. 3, pie charts indicating the current sample distributions are shown on the left side of the UI, and pie charts indicating the desired sample distributions are shown on the right side of the UI. The side-by-side display of the current distribution and the desired distribution makes it easier for a user to view and understand the sample imbalance. Moreover, the UI can motivate the user to help improve the imbalance by gamification of the recruiting process. In the example shown in FIG. 3, the user is provided with a monetary reward if he can recruit participants within desired demographic categories. For example, the desired gender distribution of individuals in the sample body should be 50% male and 50% female, but currently male participants comprise 70% of the sample, making females desired recruiting targets. In addition to monetary rewards, non-monetary incentives (such as game points, coupons, and any other motivating mechanisms) can also be used to motivate a user to recruit other participants within the desired socio-demographic category.

To motivate users to assist in the recruiting of more female participants, the UI displays a sign indicating the amount of a monetary reward ($20 in this example) given to the user if he can successfully recruit a female participant. Similarly, the user is also offered a monetary reward if he can recruit a high school graduate or a divorced person, both of which are needed to improve the sample balance. In one embodiment, recruiting an individual who falls within the least represented category deserves the most reward. In other words, the reward value for a recruit positively correlates with the difference between the current distribution of his particular type and the desired distribution. In the example shown in FIG. 3, based on the bottom pie chart, divorced individuals make up around 10% of the sample body, which is less than the desired 20% value. However, the shortage of divorced participants is less significant than the shortage of participants who are high school graduates (30% is the desired value vs. the current 10% value). Hence, $20 is provided for recruiting a high school graduate compared with the $10 provided for recruiting a divorced individual.

Note that the system dynamically updates the current sample distribution and the promised incentives. As users recruit individuals in the under-represented categories, making these categories less under-represented, the system will reduce the amount of incentives offered for those recruiting efforts. Gradually, the sample balance can be obtained as users channel their efforts toward getting the most reward and, thus, finding the individuals that are needed the most.

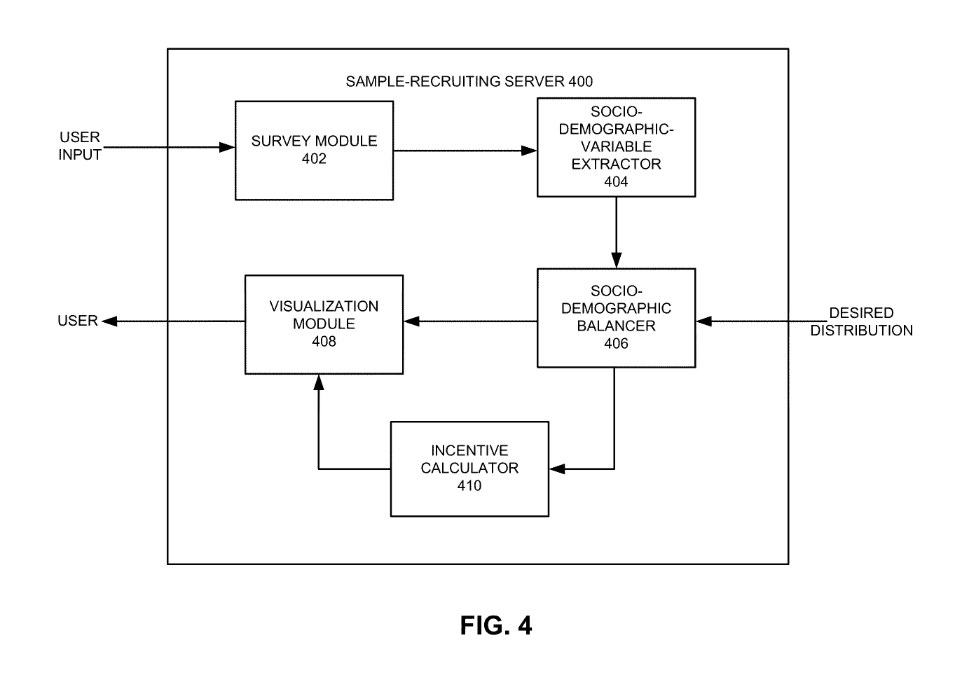

FIG. 4 presents a diagram illustrating an exemplary architecture of a sample-recruiting server, in accordance with an embodiment of the present invention. Sample-recruiting server 400 includes a survey module 402, a socio-demographic-variable extractor 404, a socio-demographic balancer 406, a visualization module 408, and an incentive calculator 410.

Survey module 402 is responsible for obtaining socio-demographic information associated with seed users. In one embodiment, survey module 402 includes a user interface that allows the seed users to fill out an online survey regarding their socio-demographic status. For example, a seed user (one that answers the open call for participation) can answer questions regarding his age, gender, marital status, ethnicity, geographic location, etc. in the online survey.

Socio-demographic-variable extractor 404 extracts socio-demographic variables associated with a user from the information obtained from the users. The socio-demographic variables are then fed to socio-demographic balancer 406, which determines whether the user should be selected for participation based on the socio-demographic balancing situation of the current sample. Socio-demographic balancer 406 is further responsible for determining distributions of various socio-demographic variables associated with participants of the current sample body. The determined current distribution and the desired distribution are both sent to visualization module 408, which visualizes and displays both the determined current sample distribution and the desired distribution. In one embodiment, visual representations of the current sample distribution and the desired sample distribution are displayed side-by-side for the user to view. In a further embodiment, visual representations of the sample distributions include, but are not limited to: pie charts, histograms, tables, statistical maps, etc.

Sometimes it may be desirable to recruit a balanced sample from multiple geographic locations, meaning that a user may be presented with distributions of a sample corresponding to his location, given that most users may recruit participants locally. For example, a user living in California may be presented with the desired sample distribution and the current distribution for participants located in California, whereas a user living in Washington, D.C. may be presented with the current distribution for participants located in Washington, D.C. In addition, based on a user's login information (which may include his ZIP code), the system may dynamically compute sample distribution and recruiting incentives for ZIP codes within a certain radius of the ZIP code of the user, and present the results to this user. In one embodiment, the system may display or advertise location-specific incentives (based on particular demographic shortages) to all users in order to have all users concentrate their recruiting efforts on certain geographical locations, such as cousins in Memphis or college friends in New Jersey.

In addition to displaying the visual representations of the sample distributions, visualization module 408 also visualizes and displays incentives provided to users for recruiting particular types of users. The incentives are calculated by incentives calculator 410. In one embodiment, incentives calculator 410 calculates the incentive associated with a particular socio-demographic variable based on the difference between the current sample distribution and the desired sample distribution. In the example shown in FIG. 3, the gender distribution of the current sample body is 70% male and 30% female, whereas the desired gender distribution is 50% male and 50% female. The percentage difference (20%) of the female participants between the current sample and desired sample is inputted to incentive calculator 410, which then calculates the incentives provided to users for recruiting a female participant.

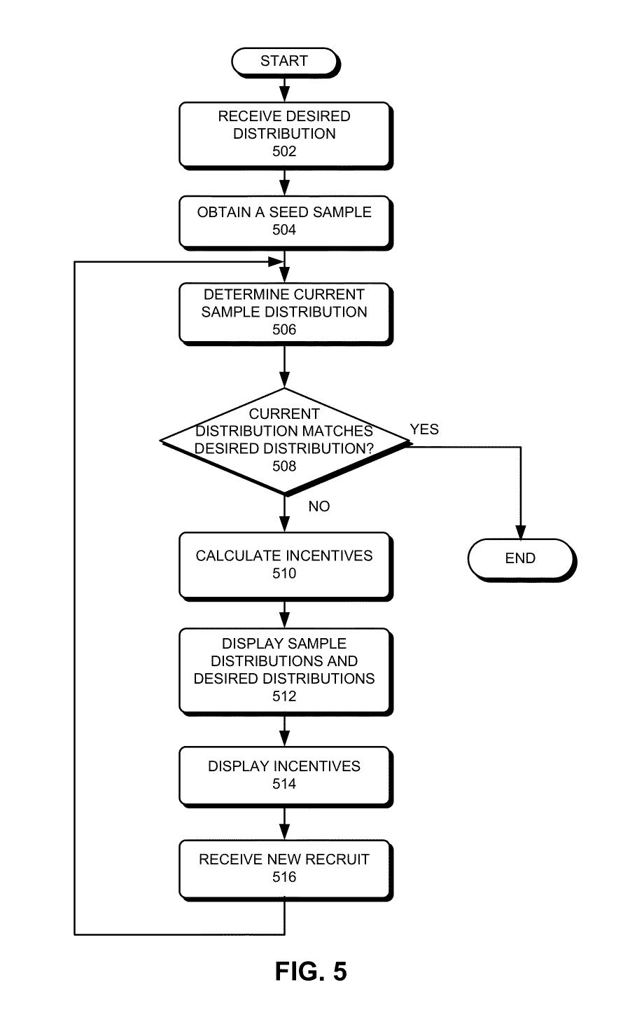

FIG. 5 presents a flowchart illustrating an exemplary process of sample recruiting, in accordance with an embodiment of the present invention. During operation, the system receives a desired socio-demographic distribution for a research study or a survey (operation 502). In one embodiment, an expert creates the desired socio-demographic distribution based on the research or survey need. For example, if the research is to be applied to the U.S. population, the desired socio-demographic distribution will be the census result for the entire country. On the other hand, if one wants to find out public opinion regarding an issue in a particular state, the desired socio-demographic distribution will be the census result for the state.

The system also obtains a seed sample, which includes a number of seed participants, and socio-demographic information associated with the seed participants (operation 504). In one embodiment, a conventional recruiting method, such as open calls to the public, can be used to recruit the seed participants. In a further embodiment, individuals answering the open calls submit their socio-demographic status via an online survey, and the system selects the seed participants based on their socio-demographic status.

Subsequently, the system determines distributions of a number of socio-demographic variables (depending on the need) for the current sample body, which includes the seed participants (operation 506). The socio-demographic variables include, but are not limited to: age, gender, marital status, ethnicity, geographic location, etc. The system compares the current distribution with the desired sample distribution (operation 508). If the current distribution matches the desired distribution, no more recruiting is needed.

Otherwise, the system further calculates incentives provided to users for recruiting further participants associated with certain socio-demographic variables (operation 510). In one embodiment, the incentives are calculated based on current sample imbalance, which positively correlates to the difference between the current sample distribution and the desired sample distribution.

On a user interface, the system displays visual representations (in the form of various types of graphs) of desired distributions of socio-demographic variables and the current sample distributions (operation 512), and displays the calculated incentives associated with the sample imbalance (operation 514). Note that this user interface can be accessible to all individuals answering the open calls regardless of whether they were selected as seed participants. By displaying the desired distribution and the current sample distribution side-by-side, the system gives its users an intuitive view of how can they help improve the sample balance. Moreover, by displaying the incentives and providing the most incentives for recruiting people in the most under-represented categories, the system effectively motivates the users to recruit the most desired participants.

The system receives a new recruit that improves the sample balance (operation 516). The new recruit can be recruited by a user of the system via the user's social network. For example, a user may forward a link to his friends or relatives. If they decide to participate, they can do so by following the link to provide their own socio-demographic information. Subsequent to receiving the new recruit, the system returns to operation 506 to update the current sample distribution, followed by operations 508 for determining whether the sample is balanced and 510 for updating the incentive calculation. Note that the incentives associated with certain socio-demographic categories or attributes gradually diminish as the socio-demographic category is filled with newly recruited individuals. Once the sample reaches the desired socio-demographic distribution, the system stops rewarding its users for their recruitment efforts. In a further embodiment, the system stops accepting new recruits once the sample number reaches a predetermined threshold and the sample distribution matches the desired distribution.

### Computer System

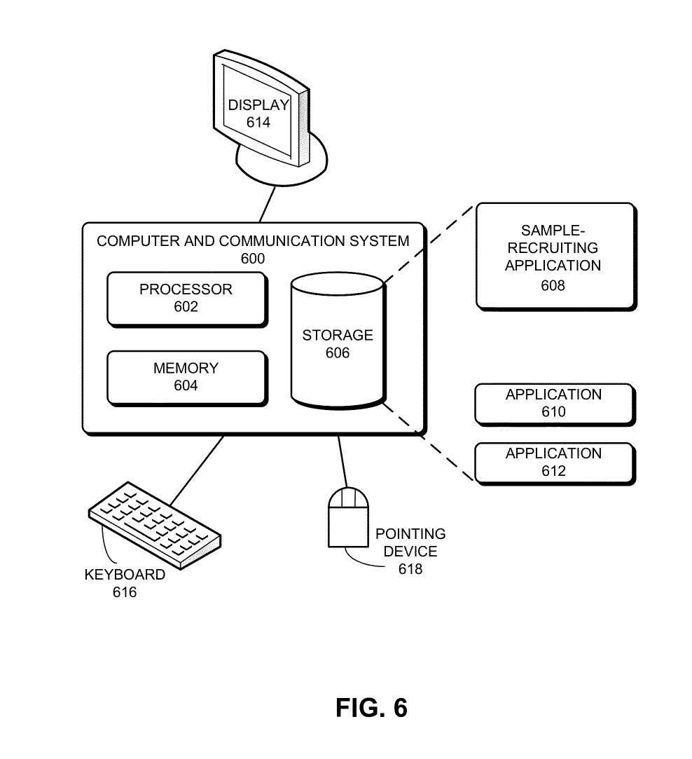

FIG. 6 illustrates an exemplary computer system for sample recruiting, in accordance with one embodiment of the present invention. In one embodiment, a computer and communication system 600 includes a processor 602, a memory 604, and a storage device 606. Storage device 606 stores a sample-recruiting application 608, as well as other applications, such as applications 610 and 612. During operation, sample-recruiting application 608 is loaded from storage device 606 into memory 604 and then executed by processor 602. While executing the program, processor 602 performs the aforementioned functions. Computer and communication system 600 is coupled to an optional display 614, keyboard 616, and pointing device 618.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

1. A computer-executable method for recruiting individuals with a desired socio-demographic distribution, the method comprising:
obtaining a participant sample comprising a plurality of participants;
calculating, by one or more computers, a recent socio-demographic distribution associated with the participant sample;
dynamically calculating, by the one or more computers based on the recent socio-demographic distribution of the participant sample, a recruitment incentive that incentivizes users to recruit an individual with a desired socio-demographic attribute;
offering, by the one or more computers, the recruitment incentive to a first user, which involves providing to the first user a description of the desired socio-demographic distribution and of the recent socio-demographic distribution of the participant sample; and
rewarding, by the one or more computers, the first user with the recruitment incentive responsive to the first user successfully recruiting a new user with the desired socio-demographic attribute.

2. The method of claim 1, wherein offering the recruitment incentive involves:
dynamically displaying visual representations of the recent socio-demographic distribution and the desired socio-demographic distribution.

3. The method of claim 2, wherein the visual representations include at least one of:
a pie chart;
a histogram;
a table; and
a statistical map.

4. The method of claim 1, wherein dynamically calculating the recruitment incentive involves comparing a difference between the recent socio-demographic distribution and the desired socio-demographic distribution.

5. The method of claim 1, further comprising receiving socio-demographic variables associated with a participant via an online survey.

6. The method of claim 5, further comprising storing the received socio-demographic variables in a database.

7. The method of claim 1, wherein the recruitment incentive includes at least one of:
a monetary incentive; and
a non-monetary incentive.

8. A non-transitory computer-readable storage medium storing instructions that when executed by a computer cause the computer to perform a method for recruiting individuals with a desired socio-demographic distribution, the method comprising:
obtaining a participant sample comprising a plurality of participants;
calculating a recent socio-demographic distribution associated with the participant sample;
dynamically calculating, based on the recent socio-demographic distribution of the participant sample, a recruitment incentive that incentivizes users to recruit an individual with a desired socio-demographic attribute;
offering the recruitment incentive to a first user, which involves providing to the first user a description of the desired socio-demographic distribution and of the recent socio-demographic distribution of the participant sample; and
rewarding the first user with the recruitment incentive responsive to the first user successfully recruiting a new user with the desired socio-demographic attribute.

9. The computer-readable storage medium of claim 8, wherein offering the recruitment incentive involves:
dynamically displaying visual representations of the recent socio-demographic distribution and the desired socio-demographic distribution.

10. The computer-readable storage medium of claim 9, wherein the visual representations include at least one of:
a pie chart;
a histogram;
a table; and
a statistical map.

11. The computer-readable storage medium of claim 8, wherein dynamically calculating the recruitment incentive involves comparing a difference between the recent socio-demographic distribution and the desired socio-demographic distribution.

12. The computer-readable storage medium of claim 9, wherein the method further comprises receiving socio-demographic variables associated with a participant via an online survey.

13. The computer-readable storage medium of claim 12, wherein the method further comprises storing the received socio-demographic variables in a database.

14. The computer-readable storage medium of claim 8, wherein the recruitment incentive includes at least one of:
a monetary incentive; and
a non-monetary incentive.

15. A computer system for recruiting individuals with a desired socio-demographic distribution, comprising:
a processor;
a memory;
a sample-obtaining mechanism configured to obtain a participant sample comprising a plurality of participants;
a distribution calculator configured to calculate a recent socio-demographic distribution associated with the participant sample;
a recruitment incentive calculator configured to dynamically calculate, based on the recent socio-demographic distribution of the participant sample, a recruitment incentive that incentivizes users to recruit an individual with a desired socio-demographic attribute;
a user interface configured to present the recruitment incentive to a first user, wherein while presenting the recruitment incentive, the user interface is configured to provide to the first user a description of the desired socio-demographic distribution and of the recent socio-demographic distribution of the participant sample; and
a rewarding mechanism configured to reward the first user with the recruitment incentive responsive to the first user successfully recruiting a new user with the desired socio-demographic attribute.

16. The computer system of claim 15, wherein the user interface is further configured to dynamically display visual representations of the recent socio-demographic distribution and the desired socio-demographic distribution.

17. The computer system of claim 16, wherein the visual representations include at least one of:
a pie chart;
a histogram;
a table; and
a statistical map.

18. The computer system of claim 15, wherein while dynamically calculating the recruitment incentive, the recruitment incentive calculator is configured to compare a difference between the recent socio-demographic distribution and the desired socio-demographic distribution.

19. The computer system of claim 15, further comprising an online survey mechanism configured to receive socio-demographic variables associated with a participant.

20. The computer system of claim 19, further comprising a database configured to store the received socio-demographic variables.

21. The computer system of claim 15, wherein the recruitment incentive includes at least one of:
a monetary incentive; and
a non-monetary incentive.
